(19) United States
(12) Patent Application Publication
(10) Pub. No.: US 2026/0079298 A1
(43) Pub. Date: Mar. 19, 2026

(54) INTEGRATED OPTICAL CHIP AND APPLICATION METHOD THEREOF, AND INTEGRATED OPTICAL SYSTEM

(71) Applicant: SILITH TECHNOLOGY (SUZHOU) CO., LTD., Shanghai (CN)

(72) Inventors: Xingyu ZHANG, Shanghai (CN); Ke ZHANG, Shanghai (CN)

(73) Assignee: SILITH TECHNOLOGY (SUZHOU) CO., LTD., Shanghai (CN)

(21) Appl. No.: 18/994,068

(22) PCT Filed: Oct. 28, 2022
(86) PCT No.: PCT/CN2022/128176

§ 371 Date: Jan. 14, 2025

(30) Foreign Application Priority Data
Aug. 4, 2022 (CN) 202210932683.9

(51) Int. Cl. G02B 6/125; G02B 6/12

(52) U.S. Cl. CPC G02B 6/125; G02B 6/12007; G02B 2006/1215

(57) ABSTRACT

The present invention provides an integrated optical chip applied in the field of optical signal transmission and a using method thereof, and an integrated optical system. The integrated optical chip includes: at least one transmission channel, at least one input device, at least one output device, a cutting line, and an optical waveguide; the transmission channel has an input end connected to the input device and an output end connected to the output device; the at least one input device, the at least one output device and the at least one transmission channel is cut off or trimmed off by the cutting line as a minimum cutting unit; and the at least one input device and the at least one output device are coupled to the optical waveguide. According to the present invention, production specifications of integrated optical chips are unified, such that no different circuit layouts need to be designed according to different port requirements; and the idle devices on the integrated optical chip are cut off or trimmed off by the cutting line according to actual requirements, to meet different application requirements.

### TECHNICAL FIELD

The present invention relates to the technical field of integrated circuits, and in particular to an integrated optical chip applied in the field of optical signal transmission and an application method thereof, and an integrated optical system.

### BACKGROUND ART

A multi-channel photonic integrated circuit, on which channels may carry optical signals with a same wavelength separated from a shared optical source or optical signals with different wavelengths separated from one or more optical sources, is widely used in the field of optical technologies. In the conventional design of multi-channel photonic integrated circuits, a layout structure of ports on each integrated circuit is specially designed according to the number and structure of required optical signal input and output ports, such that different layouts need to be made, to meet different production requirements.

Therefore, the present invention provides an integrated optical chip applied in the field of optical signal transmission and an application method thereof, and an integrated optical system, such that a multi-channel photonic integrated circuit is produced according to standard structure and specifications and a same layout can meet different application requirements.

### SUMMARY OF THE INVENTION

Embodiments of the present invention provide an integrated optical chip applied in the field of optical signal transmission and an application method thereof, and an integrated optical system, such that a multi-channel photonic integrated circuit is produced according to standard structure and specifications and meets different application requirements.

In a first aspect, the present invention provides an integrated optical chip, including: at least one transmission channel, at least one input device, at least one output device, at least one cutting line, and an optical waveguide; where the transmission channel has an input end connected to the input device and an output end connected to the output device, and the at least one transmission channel is configured for processing optical signals; the at least one input device, the at least one output device and the at least one transmission channel is cut off or trimmed off by the cutting line as a minimum cutting unit; and the at least one input device and the at least one output device are coupled to the optical waveguide for transmitting optical signals by the optical waveguide and for combining or separating the optical signals.

The beneficial effects are as follows: the integrated optical chip includes the at least one transmission channel, the at least one input device, and the at least one output device, and when the number of the transmission channels, the input devices, and the output devices is greater than or equal to the number of ports and structures that may be used in the optical chip, such that production specifications of integrated optical chips can be unified and no different circuit layouts need to be designed according to different port requirements. In addition, the at least one input device, the at least one output device and the at least one transmission channel is cut off or trimmed off by the cutting line as the minimum cutting unit, such that the idle input devices, output devices and transmission channels on said integrated optical chip can be trimmed by the cutting line according to actual requirements, to meet different application requirements.

Optionally, the input device is at least one of a demultiplexer and an optical splitter, and the output device is at least one of a multiplexer and an optical combiner. The beneficial effects are as follows: the input device includes at least one of the demultiplexer and the optical splitter, and the output device includes at least one of the multiplexer and the optical combiner, to meet processing requirements for the optical signals separated from an optical source with a same wavelength or different wavelengths.

Further optionally, the input device and the output device are arranged on the same side of the transmission channel, or the input device and the output device are arranged on two sides of the transmission channel. The beneficial effects are as follows: a more reasonable layout design can be adopted according to actual requirements.

Further optionally, the input device is the demultiplexer, and the output device is the multiplexer. The beneficial effects are as follows: the input device is the demultiplexer, and the output device is the multiplexer, to combine or separate the optical signals with different wavelengths.

Further optionally, the input device is the optical splitter, and the output device is the optical combiner. The beneficial effects are as follows: the input device is the optical splitter, and the output device is the optical combiner, to combine or separate the optical signals with the same wavelength.

Optionally, the optical waveguide includes: at least one of a channel waveguide, a ridge waveguide, a slot waveguide, a diffused waveguide, and a photonic crystal waveguide. The beneficial effects are as follows: the appropriate optical waveguide is selected according to actual production requirements.

Further optionally, a wavelength range of said optical signals includes: at least one of a visible band, an O-band, an E-band, an S-band, a C-band, an L-band, a U-band, and a mid-infrared band. The beneficial effects are as follows: the wavelength range of said optical signals includes at least one of the visible band, the O-band, the E-band, the S-band, the C-band, the L-band, the U-band, and the mid-infrared band, to expand the application range of the integrated optical chip.

In a second aspect, the present invention provides an integrated optical system, including K integrated optical chips as described in any one in the first aspect, where the K is a positive integer, and adjacent said integrated optical chips are interconnected with each other by at least one output device of one of said adjacent integrated optical chips and at least one input device of the other of said adjacent integrated optical chips to enable transmission of optical signals between said adjacent integrated optical chips.

The beneficial effects are as follows: the integrated optical system can be applicable to application scenarios that require the use of multiple said integrated optical chips, to improve the integration level of an optical integrated circuit, and during testing, said K optical chips can be energized simultaneously and tested together.

Optionally, said K integrated optical chips are arranged in an array. The beneficial effects are as follows: when said K integrated optical chips are arranged in an array, particularly in an aligned arrangement structure, the integrated optical chips in a same row or a same column can share the same cutting line, to simplify the structural design of the integrated optical system.

In a third aspect, the present invention provides an application method of integrated optical chips, including: obtaining the integrated optical chip as described in any one in the first aspect; and determining the input devices and the output devices that need to be used in the integrated optical chip, and trimming off the idle input devices and output devices by the cutting line. The beneficial effects are as follows: the idle input devices and output devices are cut off or trimmed off by the cutting line, to meet different actual requirements, without the need of making different layouts to meet different production requirements.

### BRIEF DESCRIPTION OF THE DRAWINGS

FIG. 1 shows a schematic diagram of the structure of an integrated optical chip provided by the present invention;

FIG. 2 shows a schematic diagram of the structure of another integrated optical chip provided by the present invention; and

FIG. 3 shows a flowchart of an application method of integrated optical chips provided by the present invention.

### DETAILED DESCRIPTIONS OF EMBODIMENTS

The technical solutions in the embodiments of the present application will be described below with reference to the accompanying drawings in the embodiments of the present application. In the description of the embodiments of the present application herein, the terms in the embodiments below are used only for the purpose of describing specific embodiments, but not intended to be a limitation of the present application. As used in the specification and appended claims of the present application, the singular expressions of “a”, “an”, “the”, “above”, “said”, and “this” are intended to also include the expressions of “one or more”, unless the context clearly indicates otherwise. It should also be understood that, in the following embodiments of the present application, “at least one” and “one or more” refer to one or more than two (including two). The term “and/or” is used to describe a relationship between associated objects, and indicates that three types of relationships may exist; for example, “A and/or B” may indicate: the case in which A alone exists, the case in which both A and B exist, and the case in which B alone exists, where A and B can be expressed in the singular or in the plural. The character “/” generally indicates that the contextual associated objects are an “or” relationship.

The reference to “one embodiment” or “some embodiments” described in this specification means that specific features, structures, or characteristics described in conjunction with the embodiment(s) are included in one or more embodiments of the present application. Thus, the statements “in one embodiment”, “in some embodiments”, “in other embodiments”, “in yet other embodiments” and the like, which appear in different parts of this specification, do not necessarily refer to the same embodiment, but mean “one or more embodiments, but not all embodiments”, unless otherwise specifically emphasized in other ways. The terms “include/comprise”, “contain/involve”, “have”, and their variations all mean “including but not limited to”, unless otherwise specifically emphasized in other ways. The term “connection” includes a direct connection and an indirect connection, unless otherwise specified. The terms “first” and “second” are used for descriptive purposes only, and shall not be construed to indicate or imply relative importance or imply the number of technical features indicated.

In the embodiments of the present application, the terms such as “exemplarily” or “for example” are used to indicate examples, illustrations, or explanations. Any embodiment or design solution described as “exemplarily” or “for example” in the embodiments of the present application should not be interpreted as being more preferred or advantageous than other embodiments or design solutions. Rather, the use of the terms such as “exemplarily” or “for example” is intended to present related concepts in a specific manner.

The present invention provides an integrated optical chip applied in the field of optical signal transmission and an application method thereof, and an integrated optical system, such that a multi-channel photonic integrated circuit is produced according to standard structure and specifications and is improved in integration level.

An embodiment of the present invention provides an integrated optical chip, including: at least one transmission channel, at least one input device, at least one output device, at least one cutting line, and an optical waveguide, where the transmission channel has an input end connected to the input device and an output end connected to the output device, and the at least one transmission channel is configured for processing optical signals; the at least one input device, the at least one output device and the at least one transmission channel is cut off or trimmed off by the cutting line as a minimum cutting unit; and the at least one input device and the at least one output device are coupled to the optical waveguide for transmitting optical signals by the optical waveguide and for combining or separating the optical signals. Different transmission channels may be different in function, and the present application does not limit the specific functions of said transmission channels.

When there are multiple input devices and multiple output devices, said input devices and said output devices can be arranged in a cascade structure on one side or two sides of the transmission channel. Each of said input devices includes at least one input end and at least one output end, where the input end of each of said input devices can be configured to input different signals or connect to different devices, and the output end of each of said input devices can be configured to output different signals or connect to different devices and transmission channels. Each of said output devices includes at least one input end or at least one output end, where the input end of each of said output devices can be configured to input different signals or connect to different devices and transmission channels, and the output end of each of said output devices can be configured to output different signals or connect to different devices. The optical integrated chip provided by the present application can be configured to process different signals, such that the application scope of the present application includes but is not limited to optical sensing, beam steering, optical interconnect, optical computing, etc.

To provide a more detailed introduction of a quantitative relationship among the input devices, the transmission channels, and the output devices, examples are given here.

Example 1: the input device directly connected to the transmission channel is connected to only one transmission channel, and the output device directly connected to the transmission channel is connected to only one transmission channel.

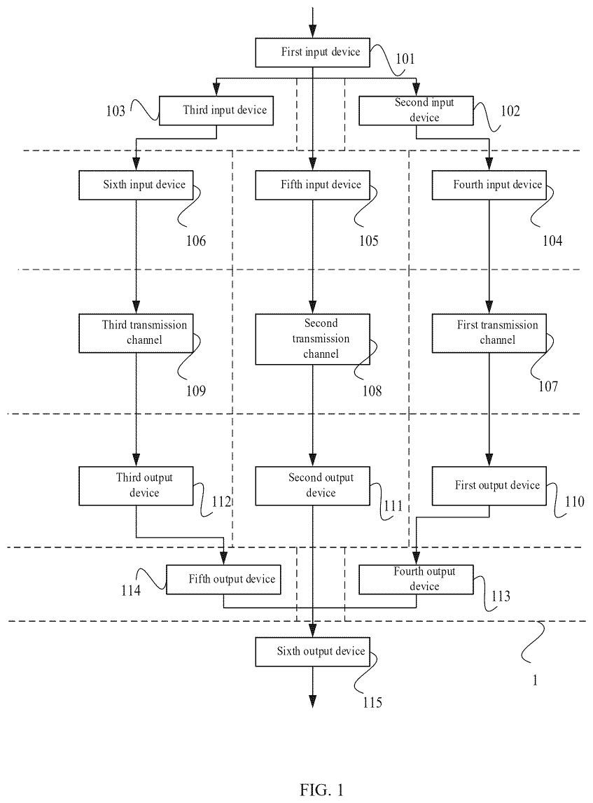

Specifically, the integrated optical chip has a structure as shown in FIG. 1 and includes six input devices, three transmission channels, six output devices, and multiple cutting lines 1. The six input devices are a first input device 101, a second input device 102, a third input device 103, a fourth input device 104, a fifth input device 105, and a sixth input device 106, respectively; the three transmission channels are a first transmission channel 107, a second transmission channel 108, and a third transmission channel 109, respectively; and the six output devices are a first output device 110, a second output device 111, a third output device 112, a fourth output device 113, a fifth output device 114, and a sixth output device 115, respectively. Each input device, each output device and each transmission channel as a minimum cutting unit. When only three input devices and three output devices are needed according to actual requirements, the first input device 101, the second input device 102, the third input device 103, the fourth output device 113, the fifth output device 114, and the sixth output device 115 need to be cut off or trimmed off by said multiple cutting lines 1 through mechanical cutting or laser cutting, to meet actual requirements. The cutting mode for the integrated optical device in actual production should not be limited to the mechanical cutting or the laser cutting. In addition, in some commonly used embodiments, the total number of input devices and output devices is 3, 6, or 12.

Example 2: the input device includes multiple output ends, and the output device includes multiple input ends. The input device directly connected to the transmission channels is connected to the multiple transmission channels by different output ends, and the output device directly connected to the transmission channels is connected to the multiple transmission channels by different input ends.

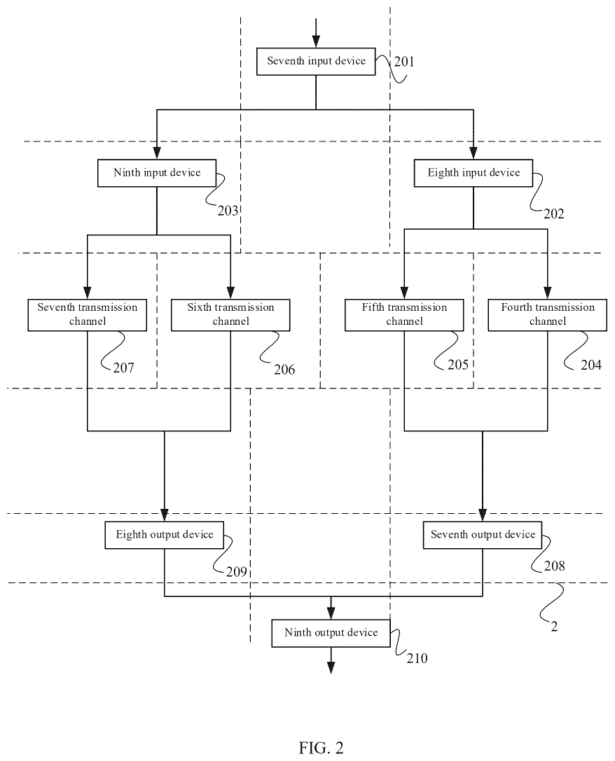

Specifically, when the input device includes one input end and two output ends, and the output device includes two input ends and one output end, each output end of the input device is configured to output different signals or connect to different transmission channels, each input end of the output device is configured to input different signals or connect to different transmission channels, and the output end of the output device is configured to output signals or connect to different output devices. As shown in FIG. 2, the integrated optical chip includes a seventh input device 201, an eighth input device 202, a ninth input device 203, a fourth transmission channel 204, a fifth transmission channel 205, a sixth transmission channel 206, a seventh transmission channel 207, a seventh output device 208, an eighth output device 209, and a ninth output device 210. The eighth input device 202, the ninth input device 203, the seventh output device 208, and the eighth output device 209 therein are connected to different transmission channels, respectively, to meet the processing requirements for different signals.

According to the present application, said integrated optical chip includes the at least one transmission channel, the at least one input device, and the at least one output device, and when the number of the transmission channels, the input devices, and the output devices is greater than or equal to the number of ports and structures that may be used in the optical chip, such that production specifications of integrated optical chips can be unified and no different circuit layouts need to be designed according to different port requirements. In addition, the at least one input device, the at least one output device and the at least one transmission channel is cut off or trimmed off by multiple cutting lines as the minimum cutting unit, such that the idle input devices, output devices and transmission channels on said integrated optical chip can be cut off or trimmed off by the cutting lines according to actual requirements, to meet different application requirements.

In a possible embodiment, the input device is at least one of a demultiplexer (demux) and an optical splitter, and the output device is at least one of a multiplexer (mux) and an optical combiner. In this embodiment, the input device is at least one of the demultiplexer and the optical splitter, and the output device is at least one of the multiplexer and the optical combiner, to meet processing requirements for the optical signals separated from an optical source with a same wavelength or different wavelengths. That is, the input end of the transmission channel should be connected to at least one of the demultiplexer and the optical splitter, and the output end of the transmission channel should be connected to at least one of the multiplexer and the optical combiner.

In another possible embodiment, the input device and the output device are arranged on the same side of the transmission channel, or the input device and the output device are arranged on two sides of the transmission channel. In this embodiment, a more reasonable design can be adopted according to actual requirements, without being bound to a certain design mode.

In yet another possible embodiment, the input device is the demultiplexer, and the output device is the multiplexer. In this embodiment, the input device is the demultiplexer, and the output device is the multiplexer, to combine or separate the optical signals with different wavelengths.

In still another possible embodiment, the input device is the optical splitter, and the output device is the optical combiner. In this embodiment, the input device is the optical splitter, and the output device is the optical combiner, to combine or separate the optical signals with the same wavelength.

In a possible embodiment, the optical waveguide includes: at least one of a channel waveguide, a ridge waveguide, a slot waveguide, a diffused waveguide, and a photonic crystal waveguide. In this embodiment, different waveguides have different cross-sectional areas, such that the appropriate optical waveguide is selected according to actual production requirements.

In another possible embodiment, a wavelength range of said optical signals includes: at least one of a visible band, an O-band, an E-band, an S-band, a C-band, an L-band, a U-band, and a mid-infrared band. In this embodiment, the wavelength range of the optical signals includes at least one of the visible band, the O-band, the E-band, the S-band, the C-band, the L-band, the U-band, and the mid-infrared band, to expand the application range of the integrated optical chip.

Based on the integrated optical chip provided by the above embodiments, an embodiment of the present application provides an integrated optical system, including K integrated optical chips as described in any one of the above embodiments, where the K is a positive integer; and adjacent said integrated optical chips are interconnected with each other by at least one output device of one of said adjacent integrated optical chips and at least one input device of the other of said adjacent integrated optical chips to enable transmission of optical signals between said adjacent integrated optical chips.

In this embodiment, the integrated optical system can be applicable to application scenarios that require the use of multiple said integrated optical chips, to improve the integration level of an optical integrated circuit, and during testing, said K optical chips can be energized simultaneously and tested together.

In a possible embodiment, said K integrated optical chips are arranged in an array. In this embodiment, when the K integrated optical chips are arranged in an array, particularly in an aligned arrangement structure, the integrated optical chips in a same row or a same column can share the same cutting line, to simplify the structural design of the integrated optical system.

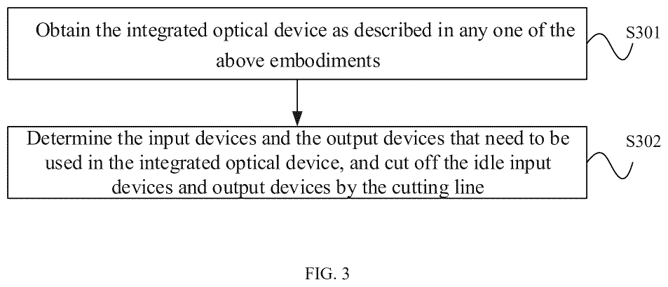

Based on the integrated optical device provided by the above embodiment, an embodiment of the present invention provides a using method of integrated optical chips, with a flowchart as shown in FIG. 3, the specific steps of which include:
S301: obtaining the integrated optical chip as described in any one of the above embodiments; and
S302: determining the input devices and the output devices that need to be used in the integrated optical chip, and trimming off the idle input devices and output devices by the cutting line.

In this embodiment, the idle input devices and output devices are cut off or trimmed off by the cutting line in a cutting mode which may be, but is not limited to, mechanical cutting or laser cutting, to meet different actual requirements, without the need of making different layouts to meet different production requirements. Actual design directions and formats of the cutting line are not limited by the embodiment and can be specifically set according to actual production requirements.

The integrated optical chip mentioned in any one of the above embodiments can be integrated on various material platforms, including: at least one of silicon wafers, silicon-on-insulator wafers, silicon-on-sapphire wafers, silicon dioxide, indium phosphide, lithium niobate, and polymers.

The foregoing are only specific implementations of the embodiments of the present application, but the scope of protection of the embodiments of the present application is not limited thereto. Any changes or substitutions within the technical scope disclosed in the embodiments of the present application should all be included in the scope of protection of the embodiments of the present application. Therefore, the scope of protection of the embodiments of the present application should be subject to the scope of protection of the claims.

1. An integrated optical chip, comprising: at least one transmission channel, at least one input device, at least one output device, a cutting line, and an optical waveguide, wherein
the transmission channel has an input end connected to the input device and an output end connected to the output device, and the at least one transmission channel is configured for processing optical signals;
the at least one input device, the at least one output device and the at least one transmission channel is trimmed off by the cutting line as a minimum cutting unit, and
the at least one input device and the at least one output device are coupled to the optical waveguide for transmitting optical signals by the optical waveguide and for combining or separating the optical signals.

2. The integrated optical chip according to claim 1, wherein
the input device is one of a demultiplexer and an optical splitter, and the output device is one of a multiplexer and an optical combiner.

3. The integrated optical chip according to claim 2, wherein
the input device and the output device are arranged on a same side of the transmission channel, or the input device and the output device are arranged on two sides of the transmission channel.

4. The integrated optical chip according to claim 3, wherein
the input device is the demultiplexer, and the output device is the multiplexer.

5. The integrated optical chip according to claim 3, wherein
the input device is the optical splitter, and the output device is the optical combiner.

6. The integrated optical chip according to claim 4 wherein the
optical waveguide comprises at least one of a channel waveguide, a ridge waveguide, a slot waveguide, a diffused waveguide, and a photonic crystal waveguide.

7. The integrated optical chip according to claim 6, wherein a wavelength range of the optical signals comprises at least one of a visible band, an O-band, an E-band, an S-band, a C-band, an L-band, a U-band, and a mid-infrared band.

8. An integrated optical system, comprising: K integrated optical chips as described in claim 1, wherein the K is a positive integer, and
adjacent said integrated optical chips are interconnected with each other by at least one output device of one of said adjacent integrated optical chips and at least one input device of the other of said adjacent integrated optical chips to enable transmission of optical signals between said adjacent integrated optical chips.

9. The integrated optical system according to claim 8, wherein said K integrated optical chips are arranged in an array.

10. An application method of integrated optical chips, comprising:
obtaining the integrated optical chip as described in claim 1; and
determining the input devices and the output devices that need to be used in the integrated optical chip, and trimming off the idle input devices and output devices by the cutting line.
